(19) United States
(12) Patent Application Publication
(10) Pub. No.: US 2012/0075051 A1
(43) Pub. Date: Mar. 29, 2012

(54) Magnetic Devices and Transformer Circuits Made Therewith

(75) Inventors: Jeffrey K. Petter, Williston, VT (US); Magdalena E. Dale, Montpelier, VT (US)

(73) Assignee: NORTHERN POWER SYSTEMS, INC., Barre, VT (US)

(21) Appl. No.: 13/154,942

(22) Filed: Jun. 7, 2011

Related U.S. Application Data
(60) Provisional application No. 61/385,718, filed on Sep. 23, 2010.
(60) Provisional application No. 61/421,083, filed on Dec. 8, 2010.

(51) Int. Cl. H01F 27/28

(52) U.S. Cl. 336/220

(57) ABSTRACT

A magnetic device producing a small amount of leakage flux and capable of substantially eliminating the amount of leakage flux that escapes the magnetic core of the device. The device includes at least a portion of an electronic circuit that includes an interphase transformer arranged on a magnetic core. The reactor windings on each leg of the magnetic core are disposed in close proximity to each other and can be wound concentrically or in a bifilar fashion. The resulting combination of the magnetic core and windings provides a high degree of magnetic coupling between reactor windings disposed on the same leg and between reactor windings disposed on differing legs. The high degree of magnetic coupling substantially reduces the amount of leakage flux that can affect other metal objects proximate the magnetic device.

### RELATED APPLICATION DATA

This application claims the benefit of priority of U.S. Provisional Patent Application Ser. No. 61/385,718, filed Sep. 23, 2010, and titled “Interphase Reactors For Multiphase Converters And Transformer Circuits Made Therewith,” and U.S. Provisional Patent Application Ser. No. 61/421,083, filed Dec. 08, 2010, and titled “Magnetic Devices and Transformer Circuits Made Therewith,” which are incorporated by reference herein in their entirety.

### FIELD OF THE INVENTION

The present invention generally relates to the field of power electronics. In particular, the present invention is directed to magnetic devices and transformer circuits made therewith.

### BACKGROUND

Multiphase power converters rely on magnetic devices, having a set of coils and a magnetic core, that parallel switching cells so that the power converters share current, average their respective voltage outputs, and filter current ripple. There are challenges to designing such magnetic devices that provide a desired electrical output while producing less heat in nearby metal components, lowering the weight of the devices, reducing the size of the devices, and producing the devices in a cost effective manner.

Problems with prior art magnetic devices are exemplified in FIG. 1, which shows a magnetic device 10 having a core 12 and a pair of coils 14A-B. In use, magnetic device 10 generates a magnetizing mode flux path 16, representing the magnetic coupling between the coils, and leakage mode flux paths 18, representing the leakage flux that is uncoupled as between/among the coils. As shown in FIG. 1, leakage mode flux paths 18 extend outside the core, into the air around magnetic device 10. For a typical DC-to-DC converter, leakage mode flux paths 18 are not generally an issue because the leakage flux are DC fields, and thus do not generally cause problems or interference in most cases. However, for an AC power converter, especially large AC power converters used for energy applications like wind, solar, or wave power, the magnetic fields along the leakage flux paths are AC magnetic fields, which cause heating in metal structures around the power converter system. AC leakage flux magnetic fields, which are not contained, can also couple into other magnetic devices and wiring nearby, causing unwanted behaviors and interference.

### SUMMARY OF THE DISCLOSURE

In one implementation, the present disclosure is directed to a magnetic device for a multiphase power converter that includes a number N of switching cells having corresponding respective N switched outputs. The magnetic device consists of a core including N legs; pairs of reactor windings each including a primary reactor winding and a secondary reactor winding, said pairs of reactor windings disposed on corresponding respective ones of said N legs, wherein said primary reactor winding and said secondary reactor winding of each respective pair of reactor windings are separated by a distance that substantially eliminates leakage inductance, and wherein each of said pairs of reactor windings have an output in electrical communication with a common output node; and N double-winding segments each including a primary reactor winding from one of said pairs of reactor windings in series with a secondary reactor winding from another one of said pairs of reactor windings, each of said N double-winding segments having a first end electronically connected to a corresponding respective one of said N switched outputs and a second end electronically connected to said common output node.

In another implementation, the present disclosure is directed to a magnetic device having magnetizing inductance and leakage inductance. The magnetic device consists of a core including a plurality of legs; and pairs of reactor windings disposed on corresponding respective ones of said plurality of legs, each of said pairs of reactor windings including a primary reactor winding and a secondary reactor winding, wherein said pairs of reactor windings are configured so that respective ones of said pairs of reactor windings magnetically couple to each other to generate the magnetizing inductance, and the leakage inductance is about 100 times less than the magnetizing inductance.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic of a prior art magnetic device;

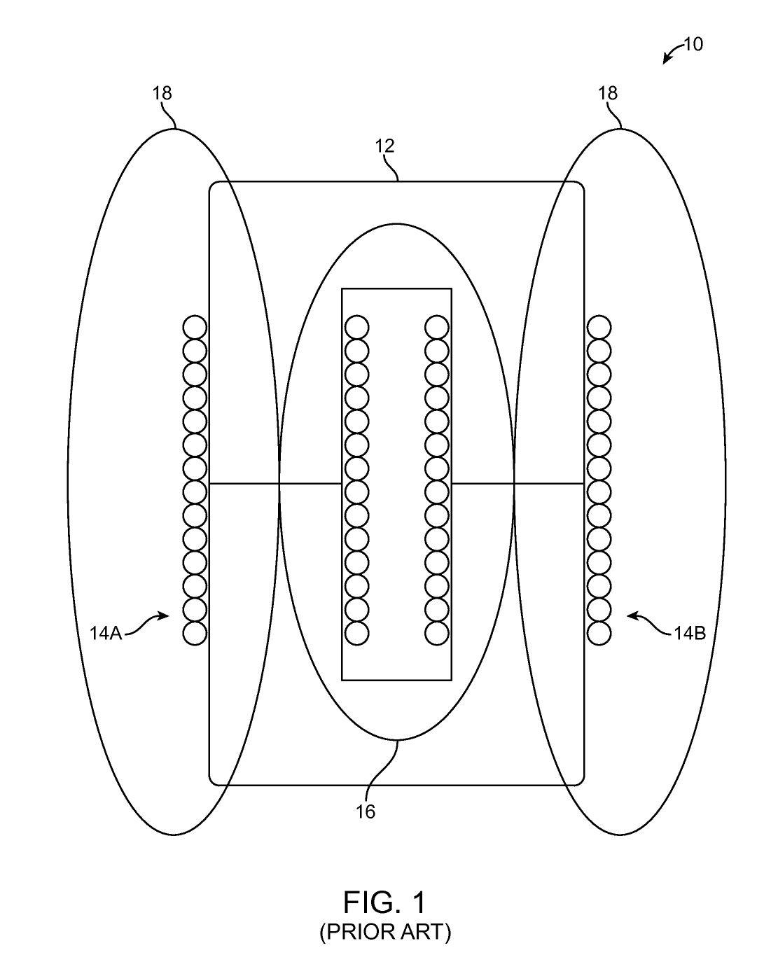

FIG. 2 is an electrical schematic of a prior art electronic circuit including an interphase transformer;

FIG. 3 is an electrical schematic of another prior art electronic circuit including an interphase transformer;

FIG. 4A is a schematic of a magnetic device implementing the circuit of FIG. 2 showing magnetic mode flux paths according to an embodiment of the present invention; and

FIG. 4B is a schematic of a magnetic device implementing the circuit of FIG. 2 showing the leakage mode flux paths according to an embodiment of the present invention.

### DETAILED DESCRIPTION

A magnetic device made in accordance with the present disclosure has a minimal amount of leakage flux and is capable of substantially eliminating the amount of leakage flux that escapes the magnetic core of the device. The result is a magnetic device that does not substantially heat or interfere with other electrical or metal components proximate the magnetic device while maintaining the desired output. Each such magnetic device accomplishes these objectives by being configured in a manner that maximizes magnetizing inductance and minimizes the amount of leakage inductance. Another way of looking at it is that a magnetic device made in accordance with the present disclosure provides a high impedance to currents flowing from input to input and a low impedance for currents flowing from input to output, thereby driving the currents that flow from input to output to be equal.

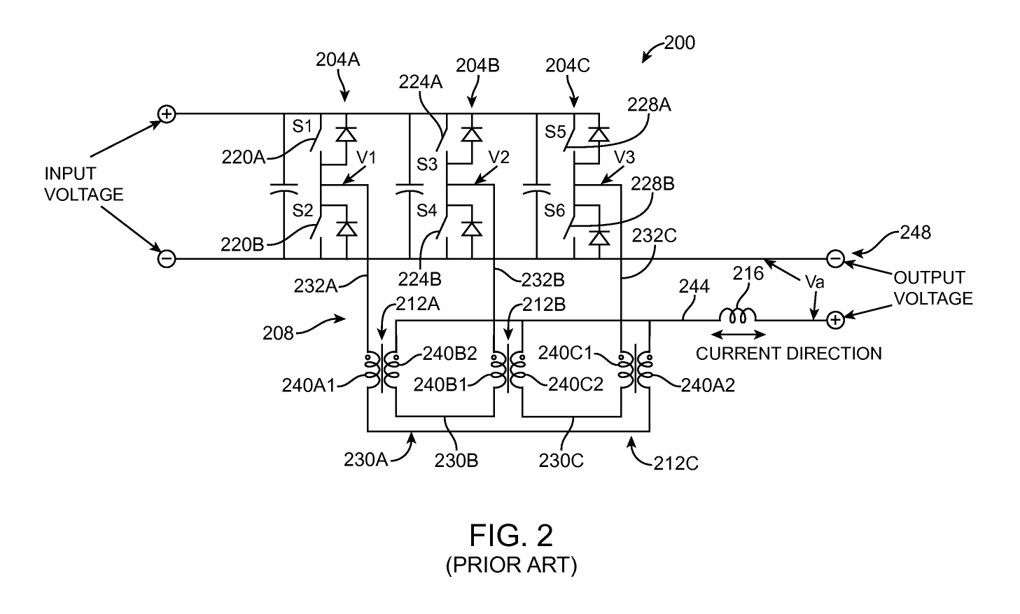

At a high level, a magnetic device made in accordance with the present disclosure includes at least a portion of an electronic circuit arranged on a magnetic core, which is described in more detail below. A schematic of a prior art electronic circuit 200 suitable for use with the magnetic device is shown in FIG. 2. Electronic circuit 200 includes, among other things, a plurality of switching cells 204A-C and an interphase transformer 208. Electronic circuit 200 can form a portion of a multiphase power converter, such as a multiphase power converter of the type described in U.S. Pat. No. 7,692,938 to Petter titled “Multiphase Power Converters and Multiphase Power Converting Methods,” which is incorporated by reference in its entirety for its disclosure of multiphase power converters.

From a magnetic prospective, electronic circuit 200 has coupled coils 212A-C that represent the magnetizing inductance and single coil 216 that represents the leakage inductance. As will be discussed further below, the arrangement of coupled coils 212A-C on the magnetic core and the architecture of the magnetic core itself generates substantial magnetizing inductance while having a small amount of leakage inductance.

Describing now the details of prior art electronic circuit 200, switching cells 204A-C are typically components similar to the switching portions of conventional converter circuits, such as basic buck/boost and half-bridge converter circuits. Each switching cell 204A-C has a pair of switches 220A-B, 224A-B, 228A-B. Switch pairs 220A-B, 224A-B, 228A-B are driven by corresponding respective comparators (not shown). One switch, e.g., 220A, 224A and 228A, in each pair is driven by a corresponding respective switch control signal that has the same phase as the output of the corresponding comparator, and the other switch, e.g., 220B, 224B, and 228B, in each pair is driven by a corresponding respective switch control signal that is 180° out of phase with the output of the corresponding comparator. Thus, the switch pairs are driven with exact opposite phasing. Further discussion of the makeup and operation of switching cells, such as switching cells 204A-C, suitable for use with circuit 200 are described in U.S. Pat. No. 7,692,938 to Petter titled “Multiphase Power Converters and Multiphase Power Converting Methods,” which is incorporated by reference for its disclosure of the same.

Interphase transformer 208 is configured to have a number of double-winding circuit segments 230 equal to the number of switching cell outputs 232. As shown in FIG. 2, interphase transformer 208 includes three double-winding circuit segments 230A-C connected to a corresponding one of three switching cell outputs 232A-C. This configuration accounts for all three sub-phases generated by switches 204A-C. Each output 232A-C of respective switching cells 204A-C is connected to a respective coupled coil 212A-C. Each coupled coil 212A-C includes a corresponding respective pair of reactor windings 240A1-2, 240B1-2, 240C1-2. In the present example, coupled coil 212A includes reactor windings 240A1 and 240B2 of outputs 232A and 232B, respectively, coupled coil 212B includes reactor winding 240B1 and 240C2 of outputs 232B and 232C, respectively, and coupled coil 212C includes reactor windings 240C1 and 240A2 of outputs 232C and 232A, respectively. In this example, single coil 216 is provided between common output node 244 and output 248 of circuit 200. Further discussion of the makeup and operation of double-winding circuit segments 230 and coupled coils 212 suitable for use with circuit 200 are described in U.S. Pa. No. 7,692,938 to Petter titled “Multiphase Power Converters and Multiphase Power Converting Methods,” which is incorporated by reference for its disclosure of the same.

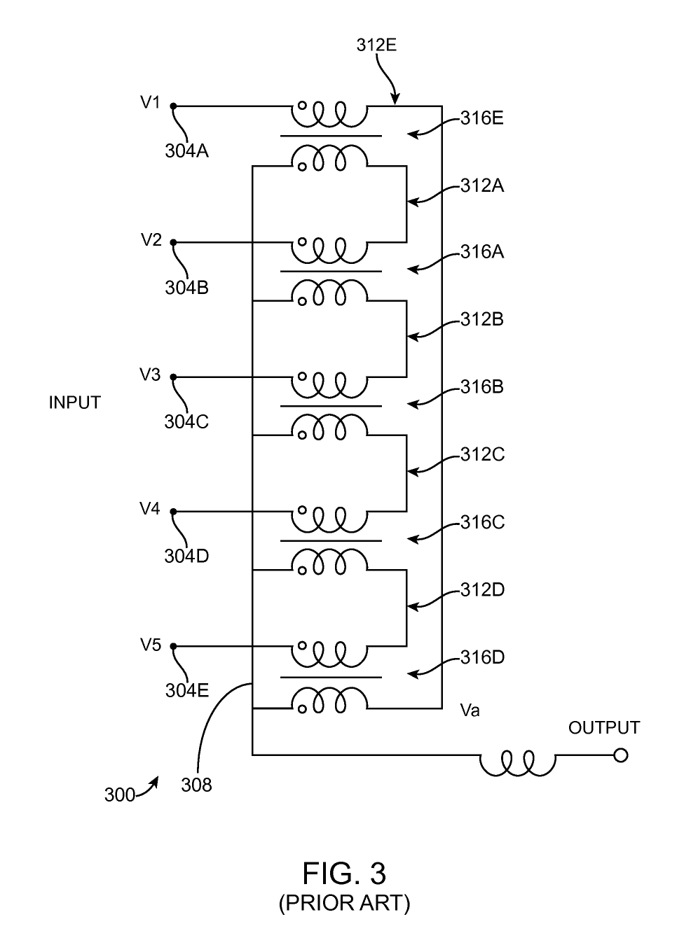

The layout of electronic circuit 200 of FIG. 2 can readily be adapted to virtually any number of switching cell outputs. For example, FIG. 3 illustrates the basic concepts described relative to circuit 200 of FIG. 2 in the context of a circuit 300 having more than three switching cell outputs 232. In circuit 300 of FIG. 3, each switching cell output 304A-E (switching cells not shown) is connected to a common output node 308 via a corresponding double-winding circuit segment 312A-E. This configuration of double-winding circuit segments 312A-E allows the formation of corresponding respective coupled coils 316A-E. Those skilled in the art will readily be able to use the basic concepts of each of circuits 200 and 300 to create a suitable circuit for any number of inputs greater than one.

The basic configuration of circuits 200 and 300 have a number of advantages over the basic configurations of similar circuits, including: 1) the magnetic components, for example, coupled coils 212A-C or 316A-E, can all be identical; 2) any number of switching cell outputs can be used (again, FIGS. 2 and 3 show three and five inputs); and 3) the magnetic cores required are readily available in any material required.

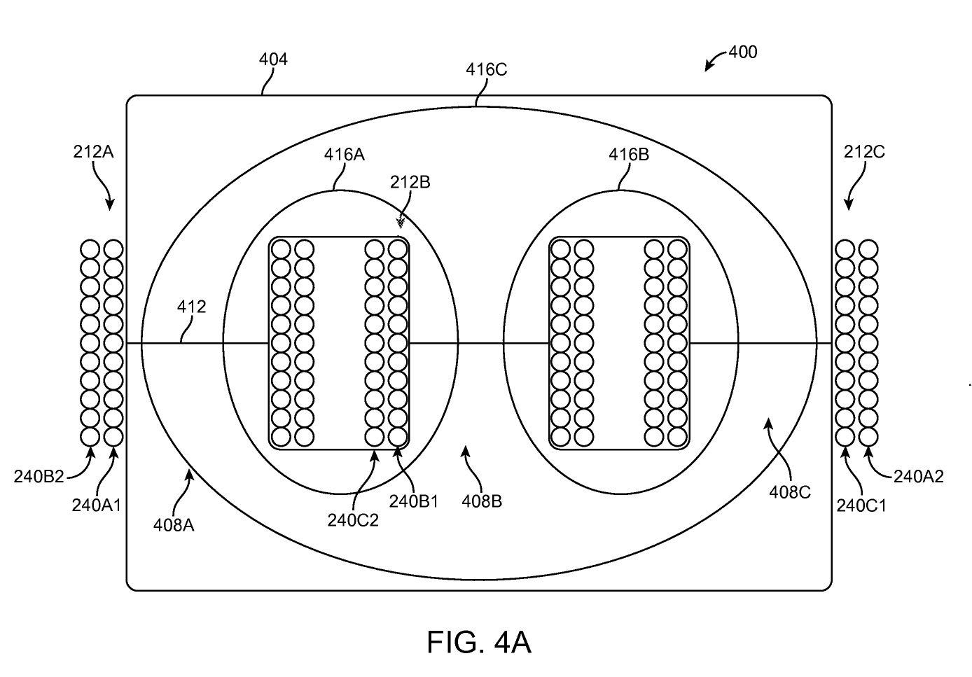

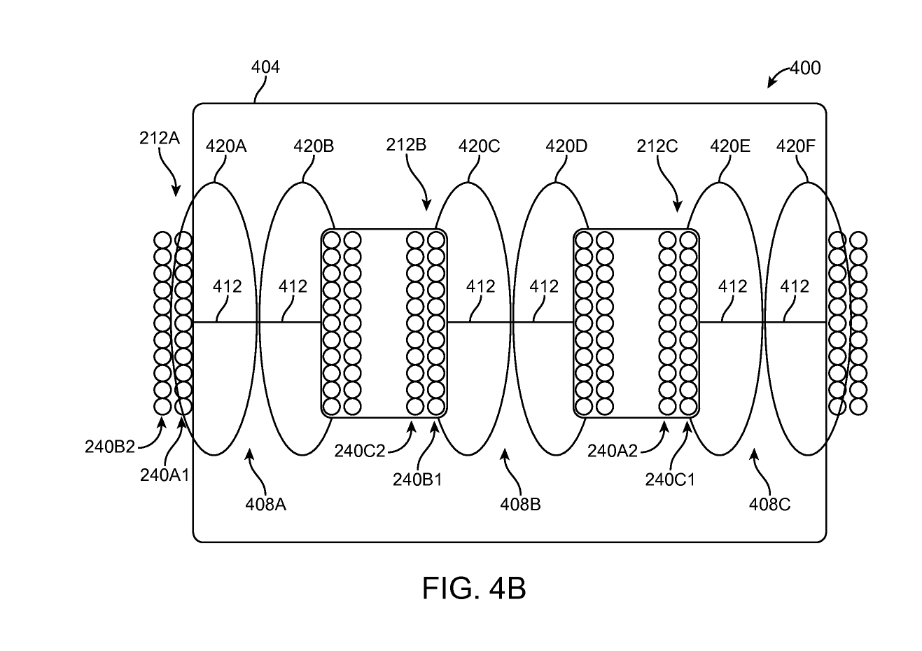

FIGS. 4A-B illustrate an exemplary magnetic device 400 implementing a transformer circuit, such as interphase transformer 208 of FIG. 2. For ease of discussion and as used in this example, reference numbers of elements of transformer 208 will be used for corresponding elements in magnetic device 400. Magnetic device 400 includes a magnetic core 404 that has three legs 408A-C. The number of legs 408 included with magnetic core 404 corresponds to the number of switching cell outputs, such as switching cell outputs 232 (FIG. 2). Thus, as would be readily apparent to those of ordinary skill in the art, to implement circuit 300 of FIG. 3 would require a magnetic core with five legs (not shown).

Wrapped around each of legs 408A-C is a pair of reactor windings 240 having a primary winding to secondary winding ratio of 1:1. As mentioned previously, each pair of reactor windings correspond to coupled coils 212A-C. In this example, the reactor windings (i.e., reactor windings 240A1-2, 240B1-2, 240C1-2) are arranged in order to create the coupled coils 212A-B by concentrically wrapping the appropriate reactor winding around a corresponding one of legs 408A-C. Thus, coupled coil 212A, wrapped around leg 408A, includes reactor windings 240A1 (secondary) and 240B2 (primary), coupled coil 212B, wrapped around 408B, includes reactor winding 240B1 (primary) and 240C2 (secondary), and coupled coil 212C, wrapped around 408C, includes reactor windings 240C1 (primary) and 240A2 (secondary). In an alternative embodiment, reactor windings 240 may be wrapped in a bifilar fashion (not shown) in which case the appropriate reactor windings will be wrapped side-by-side on each leg 408. For the purposes of this specification, the terms “primary” and “secondary” are used for convenience, as those of ordinary skill in the art would readily understand that reactor windings 240 may all be considered primary or secondary windings because of their arrangement on magnetic device 404.

Magnetic core 404 can also include a magnetizing gap 412. The magnetizing gap 412 is adjustable so as to allow for control of the magnetizing inductance and prevent small DC magnetizing currents from saturating the core. Magnetizing gap 412 is often referred to as an air gap, but is typically filled with some other material that is non-magnetic and non-conductive such as, but not limited to, Nomex® or fiberglass. In general, the size of the air gap length is determined as a function of the application for and size of magnetic core 404. In an exemplary embodiment, the air gap length is small, e.g., on the order of about 0.05 mm to about 0.5 mm.

As shown in FIGS. 4A-B, the arrangement of the reactor windings and the configuration of magnetic device 400 induces a high degree of magnetic coupling, which is represented by magnetic mode flux paths 416A-C (FIG. 4A), thereby significantly reducing leakage flux (shown as leakage mode flux paths 420A-F (FIG. 4B)). Referring first to FIG. 4A, magnetic mode flux paths 416A-C represent the magnetic coupling that occurs between reactor windings 240 (under either a concentric winding or bifilar winding scheme). In this example, magnetic mode flux paths 416A-C represent the magnetic coupling occurring between reactor windings 240 on separate legs 408. Thus, magnetic mode flux path 416A couples reactor windings 240A1:240C2:240B1:240B2, magnetic mode flux path 416B couples reactor windings 240A2:240B1:240C1:240C2, and magnetic mode flux path 416C couples reactor windings 240A2:240A1:240C1:240B2.

FIG. 4B shows the dominant leakage flux mode paths 420A-F, which represent the leakage flux generated by magnetic device 400. As a person of ordinary skill in the art would readily understand, other, less influential, leakage flux mode paths are present that stray both inside and outside core 404. However, with a minimal amount of leakage flux generated, a minimal amount of leakage flux can extending outside core 404, thus there is less heating of steel structures around the magnetic device (such as cabinets and shelving) and there is less interference with nearby magnetic devices and wiring.

Returning now to FIG. 4A, the desired high level of magnetizing mode coupling and low level of leakage mode coupling between the primary and secondary reactor windings on each leg is achieved, at least in part, by minimizing the distance between the primary and secondary reactor windings on each of legs 408. In an example, the distance, D, between the primary and secondary reactor windings, e.g., reactor windings 240A1 and 240B2, is small relative to the diameter of the windings. For example, D can be less than about 5% of the diameter of the windings. In another example, the distance, D, between the primary and secondary reactor windings, e.g., reactor windings 240A1 and 240B2, is less than about 0.12 inches. In another example, the distance, D, between the primary and secondary windings, e.g., reactor windings 240B2 and 240A1 is less than about 0.06 inches.

Additionally, to further improve the magnetic coupling and reduce leakage between the reactor windings, magnetic device 400 can be configured such that area between the primary and secondary windings, e.g., reactor windings 240B2 and 240A1, respectively, is minimized. In an example, the area, A, between the primary and secondary windings, e.g., reactor windings 240B2 and 240A1, respectively, is less than 1/10 the area of a single reactor winding.

Increasing the amount of magnetic coupling decreases the amount of leakage inductance in the magnetic device. In an exemplary embodiment, a magnetic device, such as magnetic device 404, can have a leakage inductance that is less than about 100 times less than the magnetizing inductance. In another embodiment, a magnetic device, such as magnetic device 404, can have a leakage inductance that is less than 1000 times less than the magnetizing inductance.

Magnetic core 404 can be made in a fashion suitable for high power and high frequency applications out of many materials and by many techniques known in the art. For example, magnetic core 404 can be made from isotropic or anisotropic materials. Isotropic materials are typically made of powdered magnetic materials, such as ferrites and powdered metal, which limit the conductivity and reduce eddy current losses. Ferrites materials provide very low eddy current losses at high frequencies, but have limited flux density capabilities. In contrast, powdered metal materials can have higher flux density capabilities, but may also have high eddy current losses. Typically, however, at medium frequencies, e.g., frequencies ranging from about 1 to about 20 kHz, these materials make relatively dense designs because their flux density can be more fully utilized without experiencing significant eddy current losses.

Anisotropic materials are typically made of sheet or foil material that is either stacked or wound into magnetic cores. For the power levels and frequencies used in the power converters for renewable energy sources and other applications in the kW to MW class, tape wound cores, offering high flux densities and low eddy current losses are often used. With some of the complex shapes used to make some magnetic devices for multiphase power converter care must be taken to keep the flux in the plane of the tape. When flux crosses the tape plane the eddy current losses are much higher, so boundary crossing needs to be kept to a minimum.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A magnetic device for a multiphase power converter that includes a number N of switching cells having corresponding respective N switched outputs, the magnetic device comprising:
a core including N legs;
pairs of reactor windings each including a primary reactor winding and a secondary reactor winding, said pairs of reactor windings disposed on corresponding respective ones of said N legs, wherein said primary reactor winding and said secondary reactor winding of each respective pair of reactor windings are separated by a distance that substantially eliminates leakage inductance, and wherein each of said pairs of reactor windings have an output in electrical communication with a common output node; and
N double-winding segments each including a primary reactor winding from one of said pairs of reactor windings in series with a secondary reactor winding from another one of said pairs of reactor windings, each of said N double-winding segments having a first end electronically connected to a corresponding respective one of said N switched outputs and a second end electronically connected to said common output node.

2. A magnetic device according to claim 1, wherein said primary reactor winding and said secondary reactor winding having a turn ratio of 1:1.

3. A magnetic device according to claim 1, wherein said distance is less than the diameter of one of said pairs of reactor windings.

4. A magnetic device according to claim 3, wherein said distance is less than about 5% of the diameter of one of said pairs of reactor windings.

5. A magnetic device according to claim 1, wherein said distance is less than about 0.12 inches.

6. A magnetic device according to claim 1, wherein said distance is less than about 0.06 inches.

7. A magnetic device according to claim 1, wherein an area between said primary reactor winding and said secondary reactor winding of each respective pair of reactor windings is minimized.

8. A magnetic device according to claim 5, wherein said area is less than an area of one of said pairs of reactor windings.

9. A magnetic device according to claim 6, wherein said area is less than about 1/10 the area of one of said pairs of reactor windings.

10. A magnetic device according to claim 1, wherein said pairs of reactor windings are arranged concentrically on corresponding respective ones of said N legs.

11. A magnetic device according to claim 1, wherein said pairs of reactor windings are arranged bifilarly on corresponding respective ones of said N legs.

12. A magnetic device having magnetizing inductance and leakage inductance, the magnetic device comprising:
a core including a plurality of legs; and
pairs of reactor windings disposed on corresponding respective ones of said plurality of legs, each of said pairs of reactor windings including a primary reactor winding and a secondary reactor winding,
wherein said pairs of reactor windings are configured so that respective ones of said pairs of reactor windings magnetically couple to each other to generate the magnetizing inductance, and the leakage inductance is about 100 times less than the magnetizing inductance.

13. A magnetic device according to claim 12, wherein said primary reactor winding and said secondary reactor winding having a turn ratio of 1:1.

14. A magnetic device according to claim 12, wherein the leakage inductance is about 1000 times less than the magnetizing inductance.

15. A magnetic device according to claim 12, wherein individual ones of each of said pairs of reactor windings are separated by distance, wherein said distance is less than about 5% of the diameter of one of said pairs of reactor windings.

16. A magnetic device according to claim 15, wherein said distance is less than about 0.12 inches.

17. A magnetic device according to claim 12, wherein an area between said pairs of reactor windings is minimized.

18. A magnetic device according to claim 17, wherein said area between said pairs of reactor windings is less than an area of one of said pairs of reactor windings.

19. A magnetic device according to claim 18, wherein said area between said primary reactor winding and said secondary reactor winding is less than about 1/10 the area of one of said pairs of reactor windings.

20. A magnetic device according to claim 12, wherein said pairs of reactor windings are arranged concentrically or bifilarly on corresponding respective ones of said plurality of legs.
